(19) United States
(12) Patent Application Publication
(10) Pub. No.: US 2007/0021161 A1
(43) Pub. Date: Jan. 25, 2007

(54) Hand-portable radio communications device comprising relatively movable first and second portions

(75) Inventor: Marko Autti, Oulu (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/185,594

(22) Filed: Jul. 19, 2005

(51) Int. Cl. H04B 1/06; H04M 1/00

(52) U.S. Cl. 455/575.7; 455/276.1

(57) ABSTRACT

A hand-portable radio communications device comprising: including a first conducting plane in a first portion of the device; a second conducting plane in a second portion of the device; an antenna element connected to one of the first or second conducting planes; and a mechanism for enabling relative movement of the first and second portions of the device between a first configuration in which a first interconnect path exists between the first conducting plane and the second conducting plane and a second configuration in which a second different interconnect path exists between the first conducting plane and the second conducting plane.

### FIELD OF THE INVENTION

Embodiments of the present invention relate to a hand-portable radio communications device comprising relatively movable first and second parts.

### BACKGROUND TO THE INVENTION

A single feed antenna element, such as a planar inverted F antenna (PIFA) or planar inverted L antenna (PILA), uses a counterbalance to achieve effective radiation patterns. Such a single feed antenna element resonates at odd multiples of the quarter wavelength. The antenna element functions as one arm of a dipole and the counterbalance acts as the other arm. The currents in the two arms have a 180 degree phase difference. The counterbalance for a PIFA or PILA is a ground plane, which is typically provided as a printed wiring board (PWB).

To obtain resonance at a resonant wavelength λ it is desirable for the ground plane to have an effective electrical length of the order of λ/4. An internal antenna of a mobile cellular telephone which uses the PWB as a ground plane and for resonance at GSM 900 the preferred PWB length is typically between 90 mm and 120 mm and for resonance at PCN/DCS 1800 the preferred PWB length is typically between 50 mm and 70 mm.

However, there is a general trend towards the miniaturization of mobile cellular telephones. As such, it is often desirable to split the single PWB into two electrically interconnected but physically separate PWBs. Each of the PWBs are typically carried in different parts of the device that move relative to one another, for example, by folding or sliding.

The two-part phone has a closed configuration in which a first PWB and a second PWB overlap and an open configuration in which the first PWB and he second PWB are moved further apart.

A problem can arise because the antenna's performance may be affected by relative displacement of the first and second PWBs. Therefore, although the antenna may function well in one configuration it may function less well in the other configuration.

The inventors have realized that a reason for performance degradation is that the RF currents in one PWB may start to cancel those in the other when the configuration is changed. This performance degradation particularly affects the lowest resonant mode of the antenna arrangement which is typically for US-GSM850 or E-GSM900.

### BRIEF DESCRIPTION OF THE INVENTION

According to one embodiment of the invention there is provided a hand-portable radio communications device comprising: a first conducting plane in a first portion of the device; a second conducting plane in a second portion of the device; an antenna element connected to one of the first or second conducting planes; and a mechanism for enabling relative movement of the first and second portions of the device between a first configuration in which a first interconnect path exists between the first conducting plane and the second conducting plane and a second configuration in which a second different interconnect path exists between the first conducting plane and the second conducting plane.

According to another embodiment of the invention there is provided a hand-portable radio communications device comprising: a first printed wiring board in a first portion of the device; a second printed wiring board in a second portion of the device; an antenna element connected to one of the first or second printed wiring boards; and a mechanism arranged to enable the relative movement of the first and second portions of the device and the simultaneous variation of a length of an interconnect path between the first printed wiring board and the second printed wiring board.

According to another embodiment of the invention there is provided a hand-portable radio communications device comprising: a first ground plane in a first portion of the device; a second ground plane in a second portion of the device; an antenna element connected to one of the first and second ground planes; a mechanism for enabling the relative movement of the first and second portions of the device between a first configuration and a second configuration; a first interconnect path between the first ground plane and the second ground plane when the first and second ground planes have a first relative position corresponding to the first configuration of the device; and a second different interconnect path between the first ground plane and the second ground plane when the first and second ground planes have a second relative position corresponding to the second configuration of the device.

The inventors have realized that changing the interconnect path between the first and second PWBs between the first and second configurations compensates for the effects of relatively displacing the PWBs.

### BRIEF DESCRIPTION OF THE DRAWINGS

For a better understanding of the present invention reference will now be made by way of example only to the accompanying drawings in which:

FIG. 1A schematically illustrates a two-part hand-portable radio communications device in a closed configuration; and

FIG. 1B schematically illustrates the two-part hand-portable radio communications device in an open configuration.

### DETAILED DESCRIPTION OF EMBODIMENTS OF THE INVENTION

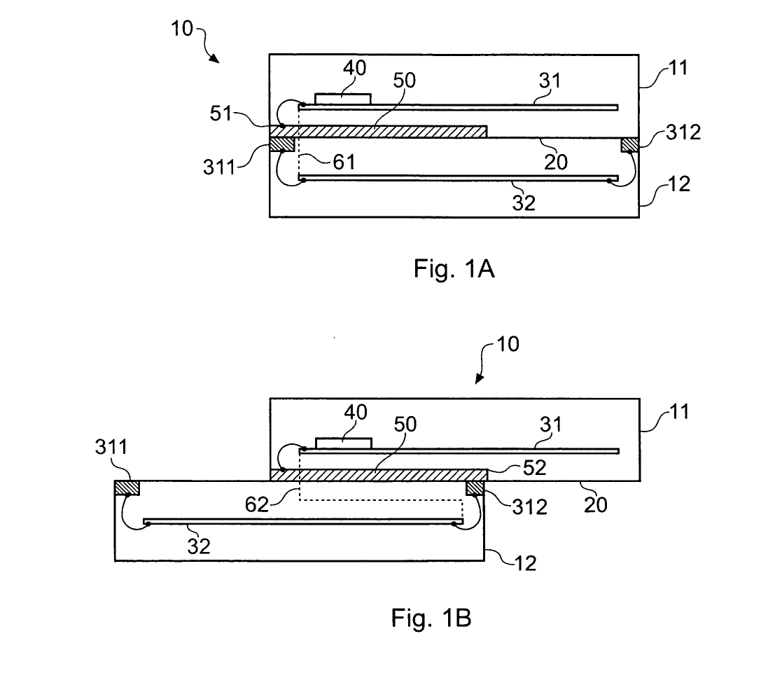

FIGS. 1A and 1B schematically illustrates a hand-portable radio communications device 10 comprising a first part 11, a second part 12 and a mechanism 20 for enabling relative movement of the first and second parts of the device 10 between a closed configuration, illustrated in FIG. 1A, in which the first and second parts are overlapping and an open configuration, as illustrated in FIG. 1B, in which the first and second parts are relatively displaced.

In the illustrated embodiment, the mechanism 20 is a sliding mechanism that allows the first part 11 and the second part 12 to slide relative to one another without changing their relative inclination. In other embodiments, the mechanism may be a hinge mechanism that allows the first and second portions to rotate about a common axis passing through the hinge mechanism.

The first part 11 comprises a first printed wiring board 31 and the second part 12 comprises a second printed wiring board 32. An antenna element 40 is connected to one of the first or second PWBs 31, 32. In the illustrated example, the antenna element 40 is a PIFA antenna element connected to the first PWB 31.

A conductive interconnect 50 connects the first PWB 31 and the second PWB 32. In this example, the first PWB is connected to a fixed metallic conductive interconnect 50 of constant size.

The conductive interconnect 50 may be integrated into the mechanism 20 for example as metalized plastic on the runners of a sliding mechanism or as a metalized part of a hinge mechanism. The conductive interconnect 50 may alternatively be a metallic spring that is connected between the first and second parts 11, 12. It extends in the open configuration and retracts in the closed configuration.

The first PWB 31 supporting the antenna element 40 is a conducting plane and acts as a ground plane for the antenna element 40. The second PWB 32 is also a conducting plane and because of its connection to the first PWB 31 via the conductive interconnect 50 it acts as an extension of the antenna ground plane.

When the device 10 is in the closed configuration, as illustrated in FIG. 1A, a first portion 51 of the conductive interconnect 50 contacts a first conducting portion 311 of the second part 12 that is connected to the second PWB 32. This contact forms a first interconnect path 61 between the first PWB 31 and the second PWB 32.

When the device 10 is in the open configuration, as illustrated in FIG. 1B, a second portion 52 of the conductive interconnect 50 contacts a second conducting portion 312 of the second part 12 that is connected to the second PWB 32. This contact forms a second interconnect path 62 between the first PWB 31 and the second PWB 32.

The relative offset of the first conducting portion 311 from the second conducting portion 312 is in the same direction in which the second PWB 32 slides relative to the first PWB 31 to change the configuration from closed to open.

The first and second interconnect paths 61, 62 have different respective phase delays determined by the different lengths of the first and second interconnect paths via the same conductive interconnect 50. The respective phase delays of the first and second interconnect paths 61, 62 may also be tuned using lumped capacitive/inductive components. The respective phase delays are chosen so that the antenna element 40 functions effectively in both the open and closed configurations.

In the illustrated example, the length of the conductive path and the phase delay between the first and second PWBs increases with an increase in the relative displacement between the first PWB 31 and the second PWB 32.

Although embodiments of the present invention have been described in the preceding paragraphs with reference to various examples, it should be appreciated that modifications to the examples given can be made without departing from the scope of the invention as claimed.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A hand-portable radio communications device comprising:
a first conducting plane in a first portion of the device;
a second conducting plane in a second portion of the device;
an antenna element connected to one of the first or second conducting planes; and
a mechanism for enabling relative movement of the first and second portions of the device between a first configuration in which a first interconnect path exists between the first conducting plane and the second conducting plane and a second configuration in which a second different interconnect path exists between the first conducting plane and the second conducting plane.

2. A device as claimed in claim 1, wherein the first and second interconnect paths have different respective phase delays.

3. A device as claimed in claim 1 or 2, wherein the first and second interconnect paths have different lengths.

4. A device as claimed in claim 1, 2 or 3, wherein the first and second interconnect paths use the same conductive interconnect.

5. A device as claimed in claim 4, wherein the conductive interconnect is of fixed size and the first and second interconnect paths use different portions of the conductive interconnect.

6. A device as claimed in claim 5, wherein the conductive interconnect is a portion of metal.

7. A device as claimed in claim 4, wherein the conductive interconnect is of variable length, its length varying with the relative movement of the first and second portions of the device.

8. A device as claimed in claim 7, wherein the conductive interconnect is a spring.

9. A device as claimed in any preceding claim 1, wherein the first conducting plane is connected to a conductive interconnect for connecting the first conducting plane to the second conducting plane, wherein a first portion of the conductive interconnect contacts a first portion of the second conducting plane in the first configuration and a second portion of the conductive interconnect contacts a second portion of the second conducting plane in the second configuration.

10. A device as claimed in claim 9, wherein the first portions are offset from the second portions in a first direction wherein the second conducting plane slides relative to the first conducting plane in the first direction to change from the first configuration to the second configuration.

11. A device as claimed in claim 1, wherein the mechanism increases a length of conductive path between the first and second conducting planes with increasing relative displacement between the first and second conducting planes.

12. A device as claimed in claim 1, wherein the mechanism increases a length of conductive path between the first and second conducting planes with decreasing relative overlap between the first and second conducting planes.

13. A hand-portable radio communications device comprising:
a first printed wiring board in a first portion of the device;
a second printed wiring board in a second portion of the device;
an antenna element connected to one of the first or second printed wiring boards; and
a mechanism arranged to enable the relative movement of the first and second portions of the device and the simultaneous variation of a length of an interconnect path between the first printed wiring board and the second printed wiring board.

14. A device as claimed in claim 13, wherein the mechanism increases the length of the interconnect path with increasing relative displacement between first and second printed wiring boards.

15. A hand-portable radio communications device comprising:
a first ground plane in a first portion of the device;
a second ground plane in a second portion of the device;
an antenna element connected to one of the first and second ground planes;
a mechanism for enabling the relative movement of the first and second portions of the device between a first configuration and a second configuration;
a first interconnect path between the first ground plane and the second ground plane when the first and second ground planes have a first relative position corresponding to the first configuration of the device; and
a second different interconnect path between the first ground plane and the second ground plane when the first and second ground planes have a second relative position corresponding to the second configuration of the device.
